(19) United States
(12) Patent Application Publication
(10) Pub. No.: US 2008/0180260 A1
(43) Pub. Date: Jul. 31, 2008

(54) Carbon monoxide and explosive gas shut off system

(76) Inventor: Harold Shirlee, Little Rock, AR (US)

Correspondence Address: Harold Shirlee, 5406 Dreher Lane, Little Rock, AR, 72209, US

(21) Appl. No.: 11/699,057

(22) Filed: Jan. 29, 2007

(51) Int. Cl. G08B 21/00

(52) U.S. Cl. 340/632

(57) ABSTRACT

The Carbon Monoxide and Explosive Gas Shut Off System is an invention that will shut off the source of carbon monoxide and explosive gas.

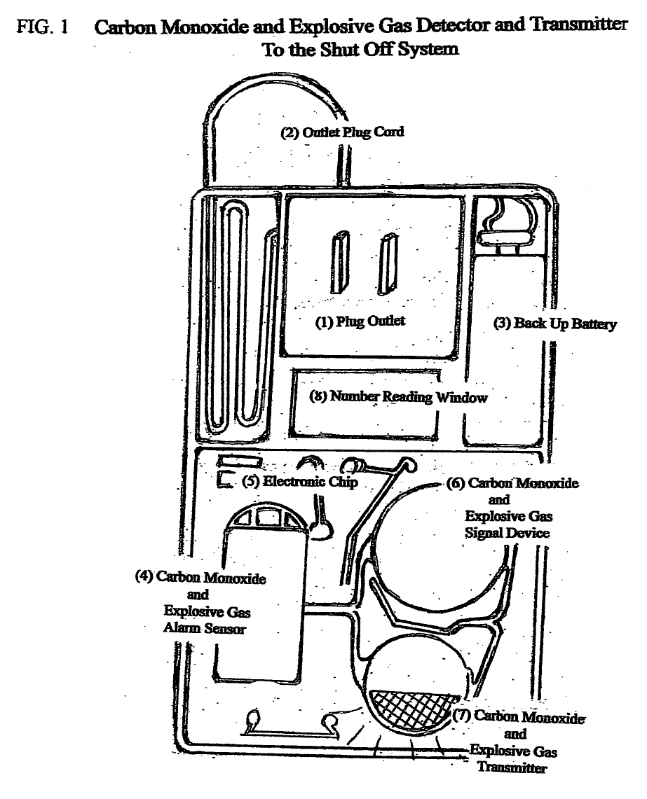

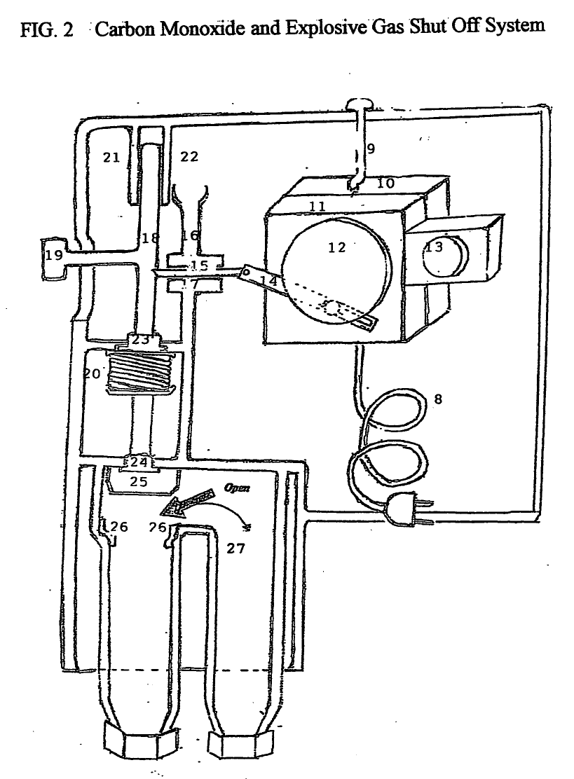

There are many types of carbon monoxide and explosive gas detectors on the market that will detect carbon monoxide and explosives gases. Unfortunately, there isn't any on the market that will actually shut off the source of carbon monoxide or explosive gases once they have been detected. Thus, there is a need for a safety system that will not only detect carbon monoxide and explosive gases, but will go a step farther by shutting down the source (furnace) that is producing the carbon monoxide or explosive gas.

The carbon monoxide and explosive gas shut off system invention will not only detect carbon monoxide and explosive gases, but it will also shut off the source (furnace) that is producing the carbon monoxide or explosive gas. This will result in human lives being saved as well as reducing property damage from explosive gases.

### SUMMARY OF THE CARBON MONOXIDE AND EXPLOSIVE GAS SHUT OFF SYSTEM

The purpose of this invention is to shut off the source of carbon monoxide or explosive gases before they become life threaten. To accomplish this objective a carbon monoxide and explosive gas shut off system will be installed between the gas supply line and the furnace. The carbon monoxide and explosive gas detector that send the signal that causes the shut off system to shut the supply of gas off from the furnace will be installed according to instructions.

When carbon monoxide or explosive gases are detected not only will this invention send out a warning sound, but it will also shut the source of carbon monoxide or explosive gases off from the furnace. This will result in human lives being saved as well as preventing property damage from explosives gases.

### BRIEF DESCRIPTION OF THE DRAWINGS OF THE CARBON MONOXIDE AND EXPLOSIVE GAS SHUT OFF SYSTEM

DRAWING 1: This is an inside view of the carbon monoxide and explosive gas detector. The feature that make this detector different than the other carbon monoxide and explosive gas detector is that it has a transmitter (drawing 1 part number 7) that send a signal to the carbon monoxide and explosive gas shut off system.

DRAWING 2: This is an inside view of the carbon monoxide and explosive gas shut off system. It shows that this system safely shut the supply source of carbon monoxide or explosive gases off by shutting off the supply line from the furnace.

### DETAILED DESCRIPTION AND OPERATION OF THE CARBON MONOXIDE AND EXPLOSIVE GAS SHUT OFF SYSTEM (DRAWING 1)

Starting with the carbon monoxide and explosive gas detector and transmitter (drawing 1) that comes as a part of the carbon monoxide and explosive gas shut off system. First the carbon monoxide and explosive gas sensor (4) will detect carbon monoxide or explosive gas. It will send that detection through the electronic chip (5) to the carbon monoxide and explosive gas signal device (6) that will make the warning sound. The carbon monoxide and explosive gas transmitter (7) is wired directly into the carbon monoxide and explosive gas signal device (6). Therefore, the same signal that the electronoc chip send to the carbon monoxide and explosive gas signal device (6) is also sent to the carbon monoxide and explosive gas transmitter (7). This signal activates the carbon monoxide and explosive gas transmitter (7) that sends out a signal to the receiver antenna (9) on the carbon monoxide and explosive gas shut off system.

### DETAILED DESCRIPTION AND OPERATION OF THE CARBON MONOXIDE AND EXPLOSIVE GAS SHUT OFF SYSTEM (DRAWING 2)

(First, the electrical cord from timer (8) is already pluged into a wall outlet from installation). The signal from the carbon monoxide and explosive gas transmitter (7) is received by the shut off timer signal receiver antenna (9). The receiver (10) receives the signal and starts the timer (11) that starts the dial wheel (12).

A situation that is brought under control: If the situation is brought under control before the timer dial wheel (12) reaches the selected number on the dial wheel (12) the override button (13) should be pushed. This will stop the timer dial wheel (12). The override button (13) will stay in the override engage position. The carbon monoxide and explosive gas shut off system will not shut off the supply of gas from the appliance.

Once the condition has been corrected the override button (13) should be pushed again. This will disengage the override button (13). Then the dial wheel (12) should be reset to the desired setting.

A situation that is not brought under: Starting with the timer dial wheel (12) in motion. When the timer dial wheel (12) has run to the end of the slot on the trigger pin lever (14) it Will pull the trigger pin (15) through the upper trigger pin guide (16) and the lower trigger pin guide (17) from the shut off shaft (18). This will allow the shut off tension spring (20) to release. This will cause the shut off shaft (18) to slide down through the left upper shaft guide (21) and the right upper shaft guide (22), through the upper gas seal (23) and through the lower gas seal (24). This forces the shut off cap (25) down to the incoming gas supply line shut off seal (26). With the gas supply being shut off from the supply line to the appliance (27) the source of carbon monoxide or explosive gas has been stopped.

RESET: With the right hand turn dial wheel (12) clockwise until the trigger pin lever (14) pushes the trigger pin (15) until it hits the shut off shaft (18). Keep a slight amount of pressure on the dial wheel (12). With the left hand lift the off and on lever (19) up to on position. You will feel the trigger pin (15) fall into the lock position. The carbon monoxide and explosive gas shut off system is back in operation.

1. A carbon monoxide and explosive gas shut off system comprising:
an electrical powered (1) battery backed up (3) carbon monoxide and explosive gas sensor (4) that sends a signal to electronic chip (5) to the detector signal device (6) to the detector transmitter (7) that sends a signal to the carbon monoxide and explosive gas shut off system that is powered by a timer electrical cord (8) that causes the receiver antenna (9) to receive a signal from the transmitter (7) that send signal to receiver (10) to timer (11) that starts dial wheel (12) if override button (13) is not pushed, dial wheel (12) will engage trigger pin lever (14) that will pull trigger pin (15) through upper trigger pin guide (16) and lower trigger pin guide (17), pulling trigger pin (15) from shut off shaft (18) moving off and on lever (19) to off position, releasing tension spring (20) causing the shut off shaft (18) to move through left shaft guide (21), right shaft guide (22), upper gas seal (23), lower gas seal (24) forcing shut off cap (25) through incoming gas line (26 into incoming gas seal (26) stopping the supply of gas to gas supply line (27) to the furnace.
